(19) United States
(12) Patent Application Publication
(10) Pub. No.: US 2004/0000445 A1
(43) Pub. Date: Jan. 1, 2004

(54) Hydrostatic drive system for low floor vehicle

(76) Inventors: Mark C. Smith, Troy, MI (US); John L. Bennett, Fraser, MI (US); Chihping Kuan, Rochester Hills, MI (US); John Ma, Rochester, MI (US); William Sullivan, Newark, OH (US); Edward J. Eshelman, Rochester Hills, MI (US); Dean Mark House, Pataskala, OH (US); Tomaz D. Varela, Gahanna, OH (US)

Correspondence Address: CARLSON, GASKEY & OLDS, P.C., 400 WEST MAPLE ROAD, SUITE 350, BIRMINGHAM, MI, 48009, US

(21) Appl. No.: 10/180,635

(22) Filed: Jun. 26, 2002

(51) Int. Cl. B60K 7/00

(52) U.S. Cl. 180/308

(57) ABSTRACT

A hydrostatic drive system for a mass transit vehicle includes an engine that drives a hydraulic pump. The hydraulic pump circulates high-pressure fluid through a circuit to two slave motors disposed at each driven wheel. The slave motors include a shaft rotated in proportion to the flow of fluid to drive a driven gear disposed on an axle supported by the frame of the motor vehicle. The hydrostatic drive transmits power from the engine through fluid pressure circulated by a hydraulic pump to the slave motors through a circuit composed of tubes or hoses. The tubes or hoses require little space compared to an axle assembly of a prior art inverted portal axle system.

### BACKGROUND OF THE INVENTION

This invention relates to a drive system for a mass transit vehicle and specifically to a hydrostatic drive system for a mass transit vehicle to eliminate the need for a drive axle assembly.

Mass transit vehicles, such as trolley, buses, and the like typically have seats aligned at the lateral sides of the vehicle, with a central aisle and floor extending along the vehicle. In order to facilitate entering and exiting from the vehicle, it is desirable to have the vehicle floor and aisle positioned relatively low to the ground. Positioning the floor of the vehicle low to the ground has the advantage of requiring only one step up from the ground into the vehicle to improve the time required for ingress and egress.

The low floor of such vehicles complicates the use of a conventional drive axle that drives the wheels through a connection along a common longitudinal axis. Typically, a portal axle is employed to allow for the floor to be set extremely low. Conventional portal axle configurations include axles disposed a portal distance from the axis of wheel rotation that engage drive assemblies at each driven wheel to transmit power to drive the wheels about the axis of rotation. In other words, instead of the standard differential including drive axles common to the axis of rotation with the driven wheels, the portal configuration transmits power from the primary mover to a point below the longitudinal axis of rotation of the wheels.

Conventional portal axle assembles are complex, expensive and can be noisy. Further, portal axle assemblies are heavier than comparable standard axle assemblies. The increased weight detrimentally affects the efficiency of the vehicle which is of concern for mass transit vehicles.

For these reasons it is desirable to develop a drive system for extreme low floor vehicle applications that is lighter, cheaper and less complex.

### SUMMARY OF THE INVENTION

An embodiment disclosed in this application is a mass transit vehicle having an extreme low floor facilitated by a hydrostatic drive system.

The hydrostatic drive system includes an engine that drives a main hydraulic pump to circulate high-pressure fluid through a circuit to at least two slave motors, disposed at each driven wheel. Each slave motor, includes a pinion gear mounted to a shaft rotated in proportion to a flow of hydraulic fluid from the main pump to drive a driven gear and an axle supported by a frame member of the motor vehicle. Hydraulic fluid is drawn from a reservoir by the main hydraulic pump and pumped through a main valve to each of the slave motors. The main valve controls the flow of high-pressure hydraulic fluid to the slave motors. Hydraulic fluid flows through the main valve to forward and reverse circuits. The main valve controls fluid pressure and flow to the slave motors, by bleeding off a portion of hydraulic fluid flow from the main pump through a return circuit. During operation the main valve is controlled to increase the flow of fluid to the slave motors, and increase the speed of the motor vehicle.

Heat absorbed within the hydraulic fluid from the slave motors is dissipated to prevent premature wear failure by a cooler within the return circuit. Hydraulic fluid from the cooler circulates back to the reservoir to supply the main hydraulic pump and recirculate through the system.

The forward and reverse circuit to each of the slave motors includes a control valve. The control valves are opened and closed to shutoff high-pressure flow to a particular slave motor. The control valves allow for different driving configurations of the system by switching which of the slave motors, drives the driven gear to provide varying speed ranges. Movement of the vehicle is controlled by a combination of opening the main valve and depressing the accelerator pedal to increase engine speed and thereby hydraulic fluid pressure and flow from the main hydraulic pump.

The hydrostatic drive system of this invention is lighter, cheaper and less complex than prior art portal axle assemblies to facilitate an extreme low floor to improve the ingress and egress of passengers of a mass transit vehicle.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a sectional view of a mass transit vehicle equipped with a hydrostatic drive system;

FIG. 2 is a schematic illustration of the hydrostatic drive system;

FIG. 3 is a schematic illustration of another embodiment of the hydrostatic drive system; and

FIG. 4 is a plan view of the gear train for driving the wheel.

### DETAILED DESCRIPTION OF THE PREFERRED EMBODIMENT

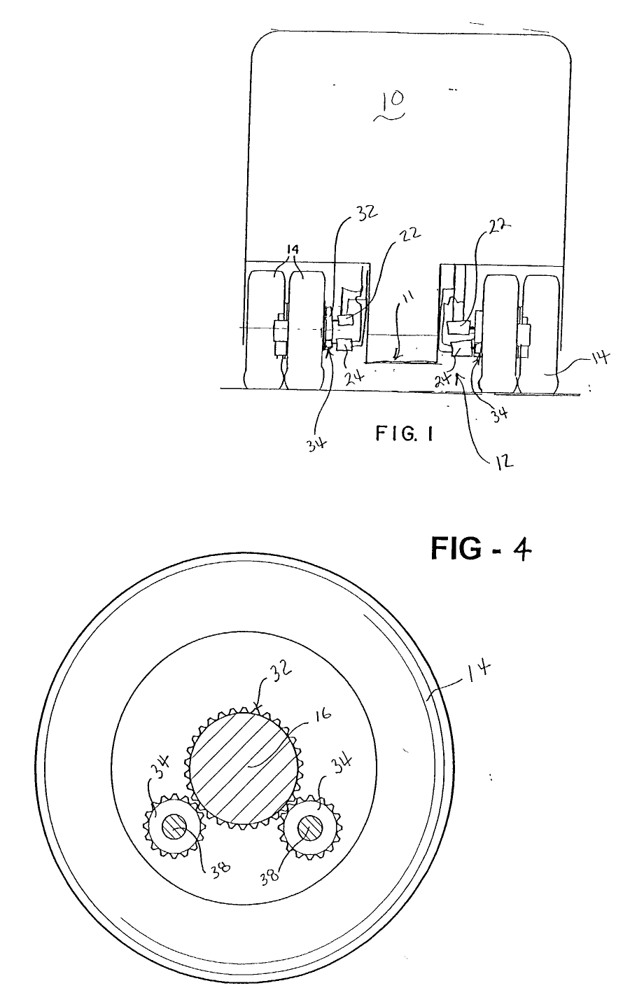

FIG. 1 is a perspective view of a mass transit vehicle 10 having an extreme low floor 11. The extreme low floor 11 improves ingress and egress from the vehicle 10 which in turn speeds total passenger loading and unloading cycle time. As appreciated the extreme low floor 11 of the vehicle complicates the use of a standard drive axle that extends along the axis of rotation of the driven wheels 14.

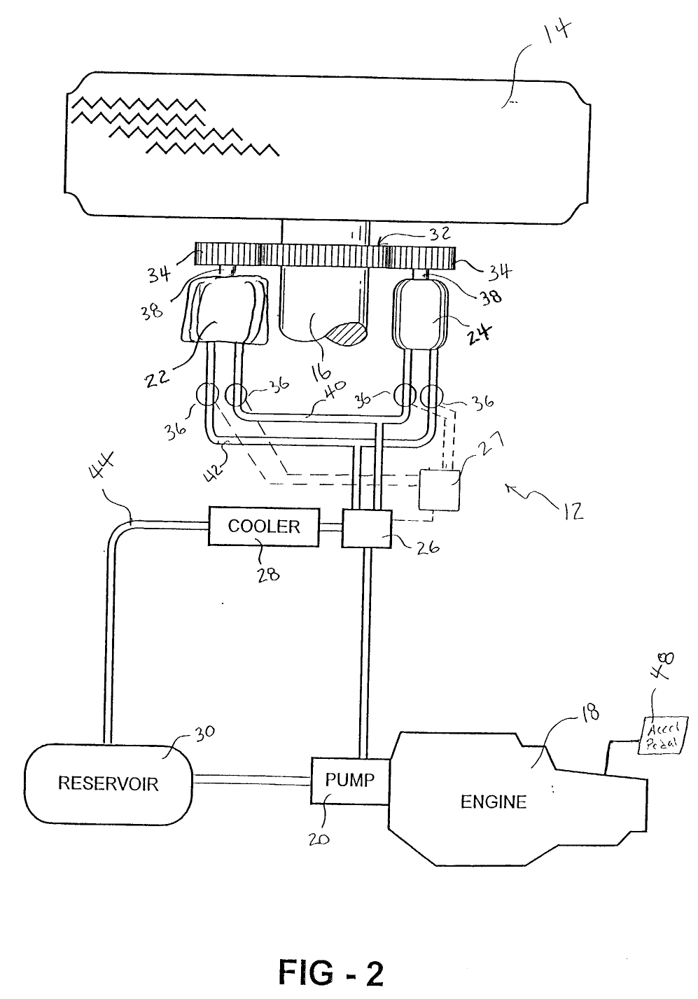

Referring to FIGS. 1 and 2, this invention is a hydrostatic drive system 12 utilizing high-pressure fluid flow to drive the wheels 14 of the motor vehicle 10. Specifically the hydrostatic drive system 12 includes an engine 18 that drives a main hydraulic pump 20. The main pump 20 circulates high-pressure fluid through a circuit to at least two slave motors 22,24 disposed at each driven wheel 14. Each slave motor 22,24 includes a pinion gear 34 mounted to a shaft 38 rotated in proportion to a flow of hydraulic fluid from the main pump 20 to drive a driven gear 32 and an axle 16 supported by a frame member (not shown) of the motor vehicle 10.

The hydrostatic drive system 12 transmits power from the engine 18 through fluid pressure circulated by the main pump 20 to drive the slave motors 22,24 through a circuit composed of tubes or hoses. The tubes or hoses are schematically illustrated in FIG. 2 and represent only one means of communicating high pressure fluid from the main pump 20 to the slave motors 22, 24. It is within the contemplation of this invention to use any fluid transportation medium as is known to one skilled in the art to communicate hydraulic fluid from the main pump 20 to the slave motors 22,24. Such fluid transportation medium can include tubes, pipes, hoses and the like. The tubes or hoses require little space compared to the axle assembly of a prior art inverted portal axle system.

A schematic illustration of the drive system shown at FIG. 2 includes the engine 18 coupled to drive the main hydraulic pump 20. Preferably, the engine 18 is an internal combustion engine, however, other types of motors and engines as known to one skilled in the art and are within the contemplation of this invention. The main hydraulic pump 20 can be either a variable displacement pump or a constant displacement pump. A variable displacement pump may provide hydraulic fluid flow through the drive system 12, either proportionally or non-proportionally, relative to engine speed. A constant displacement pump circulates the hydraulic fluid at a flow directly proportional to engine speed. Each type of pump are within the contemplation of this invention and are compatible with other aspects of this invention as described below.

Hydraulic fluid is drawn from a reservoir 30 by the main hydraulic pump 20 and pumped through a main valve 26 to each of the slave motors 22,24. The main valve 26 controls the flow of high-pressure hydraulic fluid to the slave motors 22,24. Hydraulic fluid flows through the main valve to forward and reverse circuits 40,42. The name of the circuit denotes the direction in which the slave motors 22,24 will drive the driven gear 32 in response to flow from the main valve 26. The other circuit becomes a return flow circuit back to the main valve 26. For the vehicle to be driven forward, high pressure fluid is routed through the main valve 26 and to each of the slave motors 22,24 through the forward circuit 40 and back to the main valve 26 through the reverse circuit 42. Reverse is obtained by transmitting high-pressure hydraulic fluid from the main valve 26 through the reverse circuit 42 to the slave motors 22,24 and back to the main valve 26 by way of the forward circuit 40.

The main valve 26 controls fluid pressure and flow to the slave motors 22,24 by bleeding off a portion of hydraulic fluid flow from the main pump 20 through a return circuit 44. The main valve 26 routes flow to either the forward or reverse circuits 40,42. During operation the main valve 26 is controlled to increase the flow of fluid to the slave motors 22,24 and increase the speed of the motor vehicle 10. Preferably the main valve 26 is a center valve similar to the type used in power steering systems, however it is within the contemplation of this invention to use any type of valve as known in the art.

The main valve 26 directs hydraulic fluid returned from the slave motors 22, 24 through a cooler 28 within the return circuit 44. Heat absorbed within the hydraulic fluid from the slave motors 22, 24 is preferably dissipated to prevent premature wear failure of the drive system and the cooler 28 provides this function. Hydraulic fluid from the cooler 28 circulates back to the reservoir 30 to supply the main hydraulic pump and recirculate through the system 12.

The forward and reverse circuit 40,42 to each of the slave motors 22,24 includes a control valve 36. The control valves 36 are opened and closed to shutoff high pressure flow to a particular slave motor 22,24. The control valves 36 allow for different driving configurations of the system 10 by switching which of the slave motors 22,24 drives the driven gear 32 to provide varying speed ranges.

In one embodiment, the slave motors 22,24 are of differing displacements such that one slave motor is of a higher displacement than the other. Preferably, the first slave motor 22 is of a higher displacement than the second slave motor 24. Displacement is a measure of the volume of fluid capable of flowing through a motor. At a given pressure, motors of higher displacement typically provide more torque than those of lower displacements, and motor of lower displacements provide greater flow or speed than a higher displacement motor. In summary, for equal pressures, as displacement is decreased, speeds increases and torque decreases, whereas increasing displacement increases available torque and decreases speed. This is similar to the operation of a the gears in a transmission, where the lower gears offer increased torque during lower speeds, and the higher gears provide increased speed at lower torque.

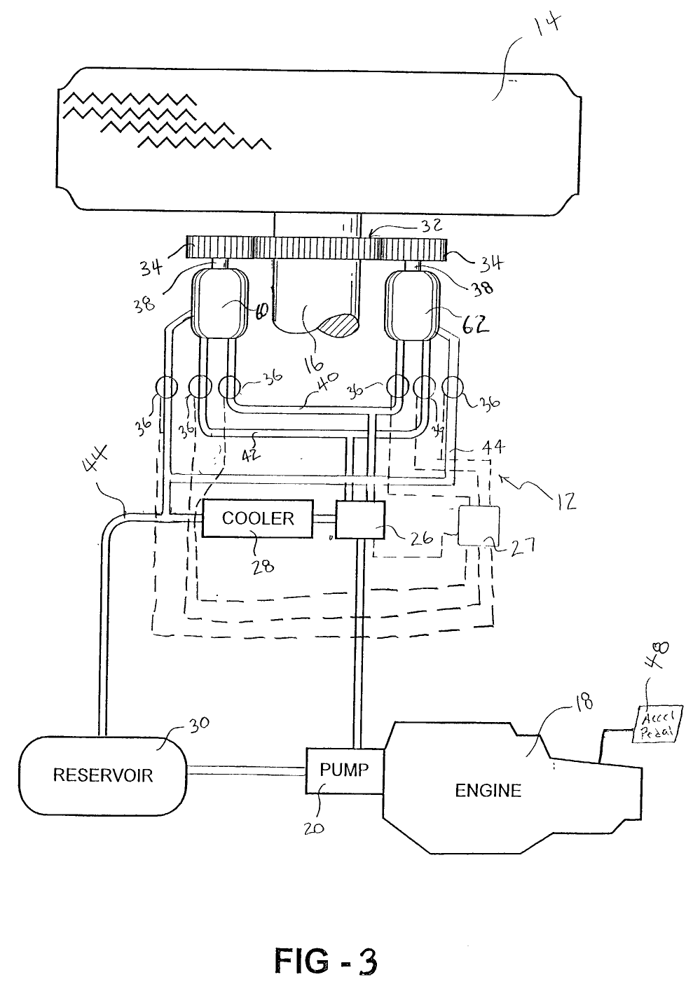

Referring to FIG. 3, in another embodiment, slave motors 60,62 are of a common displacement. Because the slave motors 60, 62 are of a common displacement only two speed ranges are possible by switching one of the slave motors 60, 62 off. The first speed range would be the lowest and includes both slave motors 60,62 driving the driven gear 32. The second speed range uses only one slave motor 60,62 to decrease the displacement and increase speed.

Referring to FIG. 2, in system 10, the control valves 36 selectively close the flow of high-pressure hydraulic fluid to provide multiple speed and torque ranges. Note that hydraulic fluid is preferably routed to each slave motor 22,24 at all times during operation for cooling purposes to prevent damage caused by excessive heat build up. However, only hydraulic fluid transmitted from the main pump 20 will allow that particular slave motor 22,24 to drive the driven gear 32. Low-pressure fluid drawn either from the return circuit or directly from the reservoir does not provide power to drive the driven gear. Preferably, cooling fluid is routed through the non-powered slave motor from the powered motor and back to the main valve 26. Referring to FIG. 3, alternatively, the non-powered slave motor may draw low-pressure hydraulic fluid directly from return circuit 44 through an additional hydraulic connection controlled by an additional control valve 36.

Referring to FIG. 2, opening of the control valves 36 to allow flow to both of the slave motors 22,24 provides the maximum displacement and therefore the lowest speed range, and highest torque. Closing the control valves 36 such that only the higher displacement pump 22 receives high pressure hydraulic fluid provides a second speed range with increased speed and lower torque than the first speed range. A third speed range is obtained by closing high pressure fluid to the higher displacement motor 22 and opening flow to the lower displacement motor 24 provide greater speed then the first and second speed ranges, at lower torque. An appropriate controller 27 is provided to selectively open and close the control valves 36 and main valve 26 as appropriate to achieve the desired speed and torque.

Referring to FIGS. 2 and 4, each shaft 38 extends from the corresponding slave motor 22,24 and includes a pinion gear 34. Each pinion gear 34 drives a driven gear 32. Preferably, the pinion gears 34 are of the same size such that the gear ratio between each pinion gear 34 and the driven gear 32 are the same. However, it is within the contemplation of this invention to include different sizes of pinion gears 34 on each of the slave motors 22,24 to provide different gear ratio combinations for each slave motor 22,24. A worker in the art would understand that although preferably a meshing engagement utilizing gears is shown, it is within the contemplation of this invention to drive the axle through other known drive means such as by pulleys, sprockets or the like.

Referring to FIG. 2, in operation, the engine 18 drives the main hydraulic pump 20. Preferably, the main hydraulic pump 20 is a variable displacement pump such that hydraulic fluid flow increases with increased engine speed and demand from an operator of the vehicle. Therefore, an operator begins moving the vehicle 10 by depressing an accelerator pedal 48 to increase engine speed and thereby hydraulic flow. The main valve 26 is in an initial condition where hydraulic fluid completely bypasses the forward and reverse circuits 40,42 to flow through the return circuit 44. The control valves 36 are actuated such that fluid flow will flow to each slave motor 22,24. To begin movement of the vehicle 10, the main valve 26 opens to allow hydraulic fluid flow to the slave motors 22,24. Both slave motors 22,24 receive hydraulic flow such that the system 10 is configured for the highest displacement and thereby lowest speed and greatest torque.

Initial speed is increased by either opening the main valve 26 toward a fully open position where no hydraulic fluid is by-passed to the return circuit 44 or by depressing an accelerator pedal 48 to increase engine speed. A combination of both opening the main valve 26 and depressing the accelerator pedal 48 provides an increase in speed of the motor vehicle. The main valve 26 can be controlled in any manner known to one skilled in the art including manual control or electronic control to optimize flow to the slave motors 22,24.

Increased speed of the vehicle 10 beyond the first speed range is accomplished by actuating the control valves 36 such that hydraulic fluid is routed only to the higher displacement slave motor 22. In this speed range, all hydraulic fluid flow from the main hydraulic pump 20 is directed through the higher displacement motor 22. The accelerator pedal 48 is actuated to increase the speed of the engine 18 and thereby increase pressure and fluid flow discharged from the main hydraulic pump 20.

Additional speed, beyond the second speed range is provided by actuating the control valves 36 to route hydraulic fluid only to the lower displacement slave motor 24 to obtain a third speed range. Control of vehicle speed within the third speed range is accomplished through a combination of accelerator pedal 48 input and main valve 26 actuation to govern the amount of hydraulic flow by-passed through to the return circuit 44.

Preferably the main hydraulic pump 20 is of a variable displacement type such that a demand signal from an operator of the vehicle and an increase in engine speed results in an increase in hydraulic pump flow. However, it is within the contemplation of this invention to use a constant displacement pump. In a drive system 10 with a constant displacement main hydraulic pump the speed of the vehicle 10 is controlled by selectively engaging specific motors to obtain the desired speed range. Specific speed within any given speed range is controlled by the main control valve 26 by controlling the amount of hydraulic fluid by-passed to the return circuit 44.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A drive system for a motor vehicle comprising;
an engine for driving a main hydraulic pump;
first and second slave motors driven by hydraulic fluid from said main hydraulic pump;
a main valve to control a flow of hydraulic fluid between said main hydraulic pump and said first and second slave motors;
a wheel driven by said first and second slave motors.

2. The drive system of claim 2, further including a forward hydraulic circuit and a reverse hydraulic circuit supplied with a flow of hydraulic fluid from said main hydraulic pump and in fluid communication with each of said first and second slave motors.

3. The drive system of claim 3, further including a control valve positioned to control a flow of hydraulic fluid to each of said first and second slave motors.

4. The drive system of claim 3, wherein said main valve is in fluid communication with said forward and reverse hydraulic circuits and a bypass circuit such that the flow of fluid through said forward and reverse hydraulic circuits is controlled by bypassing flow through said bypass circuit.

5. The drive system of claim 1, wherein each of said slave motors includes a pinion gear, and said wheel includes a driven gear driven by said pinion gears of said slave motors.

6. The drive system of claim 4, wherein said first slave motor is of a higher displacement than said second slave motor.

7. The drive system of claim 6, wherein said control valves are actuated to interrupt the flow of fluid to one of said first and second slave motors such that flow only to said first slave motor results in one speed of said wheel, and flow only to said second slave motor results in a second speed of said wheel and flow to both of said first and second slave motors results in a third speed of said wheel.

8. The drive system of claim 1, wherein said main hydraulic pump is a variable displacement pump, and displacement of said hydraulic pump varies in response to changes in engine speed.

9. The drive system of claim 1, wherein said main hydraulic pump is a variable displacement pump, and displacement of said hydraulic pump varies in response to changes in demand from an operator of the vehicle.

10. The drive system of claim 1, further including a cooler disposed within said return circuit, said cooler cools hydraulic fluid flowing through said drive system.

11. A method of controlling a hydrostatic drive system for a motor vehicle said method comprising the steps of;
a. providing first and second slave motors to drive a driven wheel of the motor vehicle,
b. driving said first and second slave motors with hydraulic fluid at a pressure and flow;
c. selectively routing fluid to each of said first and second slave motors to vary a speed range of the motor vehicle.

12. The method of claim 11, wherein said step c. is further defined by routing fluid to both of said first and second slave motors to provide a first speed range.

13. The method of claim 12, wherein said step c is further defined by routing fluid to one of said first and second slave motors to prove a second speed range.

14. The method of claim 12, wherein said slave motors are of differing displacements such that routing fluid only to said first slave motor provides a second speed range, and routing fluid only to said second slave motor provides a third speed range.

15. The method of claim 1, wherein said drive system further includes a main valve and said step c. is further defined by varying the speed within said speed range by proportionally by-passing fluid away from said first and second slave motors.
